(19) United States
(12) Patent Application Publication
(10) Pub. No.: US 2015/0316401 A1
(43) Pub. Date: Nov. 5, 2015

(54) THERMAL, FLOW MEASURING APPARATUS AND METHOD FOR DETERMINING AND/OR MONITORING FLOW OF A MEDIUM

(71) Applicant: ENDRESS+HAUSER FLOWTEC AG, Reinach (BL) (CH)

(72) Inventors: Oliver Popp, Oberwil (CH); Axel Pfau, Aesch (CH); Anastasios Badarlis, Birsfelden (CH); Frank Steinhoff, Staufen (DE)

(21) Appl. No.: 14/651,289

(22) PCT Filed: Dec. 6, 2013
(86) PCT No.: PCT/EP2013/075739

§ 371 Date: Jun. 11, 2015

(30) Foreign Application Priority Data
Dec. 14, 2012 (DE) 10 2012 112 305.5
Jun. 10, 2013 (DE) 10 2013 105 992.9

(51) Int. Cl. G01F 1/684; G01F 1/696

(52) U.S. Cl. CPC G01F 1/684; G01F 1/696

(57) ABSTRACT

A thermal, flow measuring apparatus for determining and/or monitoring flow of a measured medium through a measuring tube, comprising at least two temperature sensors, wherein a first temperature sensor is heatable, and a second temperature sensor serves to provide the temperature of the measured medium. According to the invention, the thermal, flow measuring apparatus has at least one measuring transducer for ascertaining the following properties of the medium: thermal conductivity, heat capacity, density and dynamic viscosity or thermal conductivity, thermal diffusivity, density and dynamic viscosity.

The present invention relates to a thermal, flow measuring apparatus as defined in the preamble of claim 1 as well as to a method as defined in the preamble of claim 9 and to a use of a thermal, flow measuring apparatus.

Thermal, flow measuring apparatuses function in accordance with physical principles known from thermodynamics, fluid flow, heat transfer and materials science. The underpinning functional principle is that the greater the flow velocity, the greater the heat loss rate of the measuring transducer. These two physical variables depend functionally on one another, wherein this relationship can be plotted in the form of a characteristic curve. Required in order to determine the characteristic curve, however, is much additional information in the form of constants and parameters of the medium and/or the at least one measuring transducer.

In a thermal, flow measuring apparatus, typically the power for operating a heatable temperature sensor, for example, an RTD element (acronym for Resistance Temperature Detector), is measured. The terminology, power, means, in this connection, the energy supplied per unit time to the thermal, resistance thermometer unit. Per the above mentioned principles, this value depends functionally on the flow velocity or the mass flow of a medium. There are, however, also functional dependencies between the power and other parameters, such as, for example, the temperature of the medium, its viscosity, Reynolds number, etc. These parameters must be taken into consideration in the case of determining a characteristic curve for the purpose of performing exact measurements of mass flow. Under certain circumstances, one or more parameters can be selectively disregarded, due to one or more process relevant assumptions. Furthermore, “take into consideration” means paying attention to technical design considerations and/or the inclusion of additional information. The inclusion of additional information can be performed, for example, in a calibration procedure.

The determining of the characteristic curve can be complex. In the case of thermal, flow measuring apparatuses, there are various process relevant assumptions, which can limit the complexity of the determining of a characteristic curve. For example, it can be assumed that a thermal, flow measuring apparatus is applied with media temperatures, which lie exclusively under 200 degree. Thus, additional factors, which are required for an exact characterizing of the resistance dependence of an RTD element at high temperatures, can be neglected. When free convection is characterizeable by Reynolds and Prandtl numbers, the typical flow velocities remain well below a third of the velocity of sound of the medium and the flow does not occur at negative pressure, the parameters, Grashof number, Mach number and Knudsen number corresponding to above mentioned conditions can be neglected. Furthermore, the determining of the characteristic curve can be simplified, for example, by taking into consideration the influence of temperature fluctuations in the medium by a second temperature sensor element or by lessening a measurement uncertainty of the flow value, produced, for example, by turbulence of the medium, by adapted placing of the flow measuring apparatus (e.g. widely removed from turbulence producing sections of a flow line or system of flow lines) or by the application of a flow conditioning element, which is placed in front with reference to the flow direction of the medium. In order to acquire other information, typically a calibration is performed under specific conditions at start-up or before delivery. In the calibration, various constants can be determined. Furthermore, a calibration enables in some cases the matching of a polynomial function to the characteristic curve, which, among other things, lessens the calculational complexity and the calculational effort of the calculations occurring in the measuring apparatus.

For determining a characteristic curve for a thermal, flow measuring apparatus, in spite of these considerations, executed in the above described manner, nevertheless further information is required concerning media specific properties.

So far, the evaluation processes of thermal, flow measuring apparatuses have been dependent on the specification of properties specific to the medium, such as, for example, specific heat capacity, thermal conductivity, thermal diffusivity, density and/or dynamic viscosity of the medium.

This specification can occur by manual input. Problematic, in such case, is that in the case of a medium change or in the case of a real time measurement of a medium with time-variable composition, first a switching of the measuring conditions must occur by renewed manual input of the properties of the medium.

Described In DE 692 29 799 T2 is a solution, wherein a mass flow meter for fluids comprises:

a means for storing a predetermined representation of the relationship between the Reynolds number and the Nusselt number, wherein the relationship is derived from experimental data, which are determined by bringing at least one known fluid through the flow meter at each of a plurality of flow velocities and at each of a spectrum of energy levels,

a means for calculating a target fluid film temperature from the measured measuring transducer- and fluid temperatures, wherein the film temperature represents the temperature of the target fluid bordering the measuring transducer,

a means for storing target fluid data, which represent the fluctuation of target fluid viscosity and the target fluid thermal conductivity with temperature,

a means for calculating the target fluid viscosity and the target fluid thermal conductivity from the stored target fluid data and the film temperature,

a means for calculating the Nusselt number for the target fluid from the measured energy supply rate, the difference between the measured measuring transducer temperature and the measured fluid temperature and the calculated thermal conductivity,

a means for calculating the Reynolds number for the target fluid from the calculated Nusselt number and the said relationship and a means for calculating the mass flow from the calculated Reynolds number and the calculated viscosity.

In the case of this solution, there is, however, still the problem that, in the case of a change in the medium, no error free real time measurement is possible, since a change of the medium must first be recognized, in order to set up the flow meter, so that the fitting stored target fluid data can be downloaded. Furthermore, it can occur that the exact composition of a medium/target fluid is unknown and/or that no experimental data for the properties specific to the medium in the case of some state are present or that a wrong incursion of some substance has changed the composition of the medium without being detected.

It is, consequently, an object of the invention to provide a thermal, flow measuring apparatus for determining and/or monitoring flow, which can execute a real time measurement without manual specification of properties specific to the medium or composition of the medium.

The present invention achieves this object by a thermal, flow measuring apparatus as defined in claim 1 and by a method as defined in claim 9.

According to the invention, the thermal, flow measuring apparatus for determining and/or monitoring flow of a medium through a measuring tube includes at least two temperature sensors, wherein a first temperature sensor is heatable, wherein a second temperature sensor serves to provide the temperature of the medium, characterized in that the thermal, flow measuring apparatus has at least one measuring transducer for ascertaining the following properties of the medium: thermal conductivity, heat capacity, density and dynamic viscosity or thermal conductivity, thermal diffusivity, density and dynamic viscosity.

Through use of one or more measuring transducers for ascertaining thermal conductivity, heat capacity, thermal diffusivity, density and dynamic viscosity of the medium, a medium change or even only a low concentration change can be detected and the flow measurement set to the changed conditions. The at least one measuring transducer ascertains at least thermal conductivity, heat capacity, density and dynamic viscosity or at least thermal conductivity, thermal diffusivity, density and dynamic viscosity. Other information relative to the parameters of the medium are then no longer required.

Moreover, in the case of continuous measuring or in the case of measurements of the parameters of the medium in short intervals, a real time measurement can be enabled, thus a matching of the ascertained flow values of the medium to the current composition of the medium. With the ascertained measurement data, when required, process conditions can be controlled, so that, by a corresponding process control, changes in the plant can be reacted to quickly.

It is advantageous when the thermal, flow measuring apparatus has an evaluation unit, which serves, based on the power for operating the heatable temperature sensor and the temperature difference between the at least two temperature sensors with aid of the ascertained properties of the medium, to ascertain the flow velocity and/or the flow of the medium through the measuring tube.

The evaluation unit permits correction without other supplemental devices being required. This assures a compact device construction and leads to cost savings compared with a plurality of evaluating units.

In a preferred embodiment of the thermal, flow measuring apparatus of the invention, the evaluation unit includes a means, which serves for calculating a characteristic curve based on the ascertained properties of the medium, wherein the characteristic curve is especially a characteristic line, wherein this characteristic line serves to provide a functional relationship between the power for operating the heatable temperature sensor and the flow of the medium through the measuring tube.

In an advantageous embodiment of the thermal, flow measuring apparatus of the invention, it is provided that the thermal, flow measuring apparatus is so embodied that the ascertaining of the properties of the medium and the calculating of a characteristic curve occurs within a period of time of less than 1 s, preferably less than 30 ms. In this time range, it is usually not possible for an end consumer to set the flow measuring apparatus manually to the changed conditions.

In a further development of the thermal, flow measuring apparatus of the invention, the at least one measuring transducer is designed to ascertain a value for each of the following properties of the medium: thermal conductivity, heat capacity, density and dynamic viscosity or thermal conductivity, thermal diffusivity, density and dynamic viscosity. The providing of these values enables recognition of the medium by means of the thermal, flow measuring apparatus.

In an advantageous way of implementing the thermal, flow measuring apparatus of the invention, the one or more measuring transducers for ascertaining the thermal conductivity and/or the heat capacity and/or the thermal diffusivity and/or the density and/or the dynamic viscosity of the medium are arranged in or on a bypass of the measuring tube.

A bypass is distinguished in its simplest construction by a drain from a main line and a return to the main line, in this case, the measuring tube. In an example of an embodiment of the invention, the bypass enables an easier exchangeability of the measuring transducer in the case of a defect. The bypass can be simply connected, while the defective devices are being replaced. During this time, no correction of the flow values occurs, so that the flow values can, at this point in time, only be measured with the last correction value before the repair.

Another advantageous way of implementing the thermal, flow measuring apparatus provides that the one or more measuring transducers for ascertaining the thermal conductivity and/or the heat capacity and/or the thermal diffusivity and/or the density and/or the dynamic viscosity of the medium are integrated in the measuring tube. By means of this form of embodiment, a measurement error can be lessened or prevented, wherein the measurement error due to deviations in the composition of the medium arise at different locations in the process.

In a further development of the thermal, flow measuring apparatus, the one or more measuring transducers are arranged on a rod-shaped insert, which protrudes inwardly into the measuring tube, especially radially into the measuring tube. In this case, the opportunity is provided to take into consideration certain properties (such as, for example, turbulence) of the flow.

According to the invention, a method for determining and/or monitoring flow of a medium through a measuring tube by means of the flow measuring apparatus as claimed in one of claims 1 to 8 includes a step as follows:
ascertaining respective values of the following properties of the medium: thermal conductivity, heat capacity, density and dynamic viscosity or thermal conductivity, thermal diffusivity, density and dynamic viscosity.

The ascertaining of the above mentioned thermal properties, thermal conductivity, heat capacity and thermal diffusivity, can occur by different methods such as, for example, the 3-omega method, the transient heated wire method (i.e., the transient hot wire method), the temperature oscillation method (i.e., the temperature oscillation technique) and/or by optical methods such as photo thermal and photo acoustic. The ascertaining of viscosity can occur, for example, by oscillating, vibrating and/or capillary measuring transducers. Furthermore, optical methods are known for determining viscosity, e.g. based on frequency range time resolved fluorescence anisotropy.

In a further development of the method,
a characteristic curve is calculated based on values of parameters of the medium.

In an additional further development of the method,
the flow of the medium is ascertained based on the characteristic curve and the power for operating the heatable temperature sensor and the temperature difference between the at least two temperature sensors.

In a preferred further development of the method, the ascertained values of parameters of the medium are ascertained in continuously or discontinuously recurring measurements and there occurs a fitting of the flow related values based on the currently ascertained values of the parameters of the medium.

By continuous new fitting of the flow conditions to continually changing parameters of the medium, the thermal, flow measuring apparatus enables a more exact mass balancing.

According to the invention, the thermal, flow measuring apparatus, especially as claimed in one of claims 1-8, is used for ascertaining the flow velocity of a medium having a time variable composition and/or for detecting a change in the medium during measurement operation of the thermal, flow measuring apparatus.

The invention will now be explained in greater detail based on a plurality of examples of embodiments presented in the drawing, the figures of which show as follows:

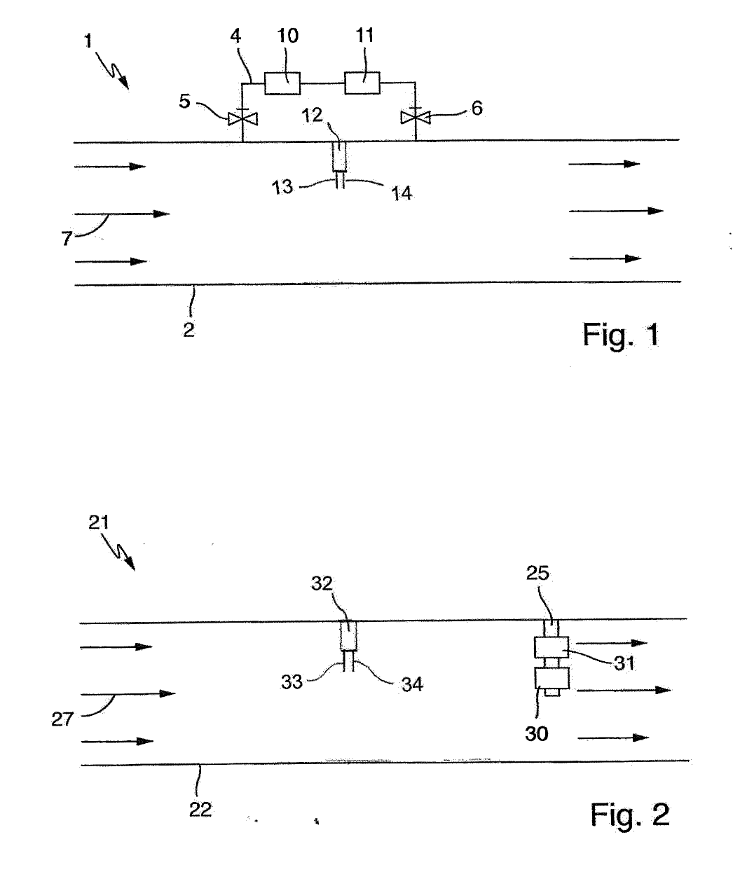

FIG. 1 a first example of an embodiment of a thermal, flow measuring apparatus;

FIG. 2 a second example of an embodiment of a thermal, flow measuring apparatus.

Conventional thermal, flow measuring apparatuses use usually two as equally as possible embodied, heatable resistance thermometers, which are arranged, most often, in pin-shaped metal sleeves, so-called stingers, or in cylindrical metal sleeves, and which are in thermal contact with the medium flowing through a measuring tube or through the pipeline. For industrial application, the two resistance thermometers are usually installed in a measuring tube; the resistance thermometers can, however, also be mounted directly in the pipeline. One of the two resistance thermometers is a so-called active sensor element, which is heated by means of a heating unit. Provided as heating unit is either an additional resistance heater, or the resistance thermometer is a resistance element, e.g. an RTD (Resistance Temperature Device) sensor, which is heated by conversion of electrical power, e.g. by a corresponding variation of the measuring electrical current. The second resistance thermometer is a so-called passive sensor element: It measures the temperature of the medium.

Usually in a thermal, flow measuring apparatus, a heatable resistance thermometer is so heated that a fixed temperature difference sets between the two resistance thermometers. Alternatively, it is also known to supply via a control unit a constant heating power.

If there is no flow in the measuring tube, then a time constant amount of heat is required for maintaining the predetermined temperature difference. If, in contrast, the medium to be measured is moving, the cooling of the heated resistance thermometer is essentially dependent on the mass flow of the medium flowing past. Since the medium is colder than the heated resistance thermometer, the flowing medium transports heat away from the heated resistance thermometer. In order thus in the case of a flowing medium to maintain the fixed temperature difference between the two resistance thermometers, an increased heating power is required for the heated resistance thermometer. The increased heating power is a measure for the mass flow of the medium through the pipeline.

If, in contrast, a constant heating power is supplied, then the temperature difference between the two resistance thermometers lessens as a result of the flow of the medium. The particular temperature difference is then a measure for the mass flow of the medium through the pipeline, respectively through the measuring tube.

There is, thus, a functional relationship between the heating energy needed for heating the resistance thermometer and the mass flow through a pipeline, respectively through a measuring tube.

FIG. 1 shows a first example of an embodiment of a thermal, flow measuring apparatus 1 of the invention for determining and/or monitoring flow of a medium through a measuring tube 2 in the case of unknown thermal conductivity, heat capacity, density and dynamic viscosity or thermal conductivity, thermal diffusivity, density and dynamic viscosity.

The flow measuring apparatus 1 includes a measuring tube 2, which is arranged in a process line by flanges or flangelessly.

Arranged in the measuring tube 2 is a rod-shaped unit 12 having a temperature sensor 13 and a heatable temperature sensor 14. The temperature sensors 13, 14 can protrude into the measuring tube 2 a distance x, so that the measuring occurs in the region of the center of the flow 7. Other arrangements of the temperature sensors 13, 14 are also possible. For example, the temperature sensors 13, 14 can protrude separately into the measuring tube 2.

In the example of an embodiment illustrated in FIG. 1, the measuring tube 2 includes a bypass 4. Introduced into this bypass 4 can be a part of the medium for determining the properties of the medium—especially the density, the thermal conductivity, the heat capacity, the dynamic viscosity and the thermal diffusivity.

The volume flow rate of the medium diverted into the bypass 4 amounts preferably to less than 2%, especially preferably less than 0.5%, of the total volume flow in the measuring tube 2, in order to keep the pressure drop as small as possible.

The properties of the medium can, depending on need, be determined continuously or—such as shown in FIG. 1—only in predetermined periods of time.

The bypass 4 includes an inlet- and an outlet valve 5 and 6. In the case of closed inlet valve 5, no pressure drop occurs in the measuring tube 2. In the case of opened inlet valve 5, the pressure drop is small due to the small diverted volume flow.

Arranged between the inlet- and the outlet valve 5 and 6 in the bypass 4 are, respectively, a measuring transducer 10 for determining the thermal diffusivity and/or the heat capacity and/or the thermal conductivity and a measuring transducer 11 for determining the density and/or the dynamic viscosity.

FIG. 2 shows a further example of an embodiment of a thermal, flow measuring apparatus 21 having a measuring tube 22 and a rod-shaped unit 32 equipped with a temperature sensor 33 and a heatable temperature sensor 34.

Measuring tube 22 includes a rod-shaped insert 25, which protrudes from the inner wall of the measuring tube 22 into the flow 27. Arranged on the rod-shaped insert 25 is a measuring transducer 30 for determining the thermal diffusivity and/or the thermal conductivity and a measuring transducer 31 for determining the density, wherein the measuring transducer 30 for determining the thermal diffusivity and/or the thermal conductivity of the medium has a smaller radial separation from the measuring tube axis of the measuring tube 22 than the measuring transducer for determining the density of the medium 31.

Other forms of embodiment provide other options, wherein e.g. the RTD elements are also arranged in a bypass 4 of the measuring tube.

The measuring transducers 10, 11, 30, 31 in the FIGS. 1 and 2 are known per se, however, their use in a thermal, flow measuring apparatus 1, 21 effects that a real time measurement is enabled or a medium change in the measuring tube 2, 22 is detected early.

The measuring transducers 10, 30 shown in FIGS. 1 and 2 for determining thermal conductivity can preferably work according to one of the methods as described in detail in connection with the thermal conductivity determination of nano fluids by G. Paul et al. in “Renewable and Sustainable Energy Reviews” 14 (2010) 1913-1924, the content of which is incorporated here by reference.

A preferred measuring transducer 10, 30 for determining thermal conductivity works according to the “temperature oscillation technique”. The basic construction of the measuring transducer 10, 30 includes a measuring cell, which is cooled on its ends by cooling water. A Peltier element arranged in the measuring cell is operated by an external electrical current source. The temperature is ascertained by a series of thermocouples, wherein the measurement signal can supplementally be amplified by an amplifier. The measurement signals are collected in an evaluation unit and compared by evaluation software.

The temperature oscillation method measures, in this way, the time temperature change of the medium, when it is exposed to a temperature change or a heat flow. The ascertained time temperature change of the medium is the result of the averaged or local thermal conductivity in the direction of the width or height of the measuring cell, in which the medium is located.

By amplitude damping of the thermal oscillation, both the thermal conductivity k as well as also the thermal diffusivity a can be ascertained.

Same as for the measuring transducers 10, 30 for determining the thermal diffusivity and/or the thermal conductivity, also measuring transducers 11, 31 for determining the density of a medium, such as they are drawn in FIGS. 1 and 2, are sufficiently known.

For this, vibrating objects can be utilized, for example, vibrating plates. Such methods and measuring transducers for determining the density 11, 31 are known per se and are described, among other things, in the article “A review of vibrating objects for the measurement of density and viscosity in oilfields including devices fabricated by the method of MEMS” from Wakeham et al, High Temperatures—High Pressures, vol. 37 pp. 137-151, the content of which is incorporated by reference. Of course, the therein published technologies are also suitable for determining the density of other media such as crude petroleum. Methods based on vibrating plates and cantilevers or quartz crystal resonators are known. The aforementioned methods enable additionally also the determining of viscosity.

Moreover, it is also possible to determine the density of various media via shear experiments. Likewise an option is to determine viscosity by means of a MOVS (micro-optical viscosity system).

The following relationship is known:

$$α = \frac{k}{ρ {c}_{p}}$$

in the case of which

α=thermal diffusivity of the medium [m²/s]

k=thermal conductivity of the medium [W/(m*K)]

ρ=density of the medium [kg/m³];

cₚ=specific heat capacity of the medium [J/(kg*K)].

In cases, in which the specific heat capacity cₚ is unknown, this relationship enables its ascertainment from the thermal diffusivity, thermal conductivity and density of the medium ascertained by the at least one measuring transducer.

In general, the power for operating the heatable temperature sensor 14, 34 (referred to as PC herein) can be correlated with the flow velocity of the medium, for example, as follows:

Assuming that the heatable temperature sensor 14, 34 stores no energy, PC equals the heat transfer (q_{C}) from the temperature sensor 14, 34 into the medium. The heat transfer is proportional the area (A) of the temperature sensor 14, 34 and the temperature difference (ΔT) between temperature sensors 13, 33 and 14, 34. The proportionality constant is called the coefficient of heat transfer (h) and can be formulated as a function of the Nusselt number (Nu).

A characteristic line can then be based on an empirical correlation between Nusselt (Nu), Reynolds (Re) and Prandtl (Pr) numbers, wherein Nu, Re and Pr are dimensionless parameters and the values of parameters of the medium, viscosity and density are required for the Reynolds number, the specific heat capacity of the medium is required for the Prandtl number and the thermal conductivity is required for the Nusselt and Prandtl numbers.

The end result is a functional relationship between the power (PC) and the values of parameters of the medium, heat capacity, thermal conductivity, density and viscosity. The measuring transducers 10, 11, 30, 31 are used, in order to obtain these values without manual input.

Through the use of these measuring transducers 10, 11, 30, 31, a short measuring path can be achieved, so that, for example, a medium change in measurement operation can be detected immediately and evaluated.

Moreover, a so-called real time measurement is possible in the case of media with continually changing compositions. Typical media are, in such case, for example, biogas, natural gas or product/reactant mixtures in reactor operations.

Referred to as real time measurement in the sense of the present invention is an adapting of the measuring conditions within a short period of time after detecting changed properties of the medium (composition or complete medium change). The short time range amounts, in such case, to less than 1 s, preferably less than 30 ms. In this time range, it is usually not possible for the end consumer to set the flow measuring apparatus 1, 21 manually to the changed conditions.

1-13. (canceled)

14. A thermal, flow measuring apparatus for determining and/or monitoring flow of a measured medium through a measuring tube, comprising:
at least two temperature sensors; and
at least one measuring transducer for ascertaining the following properties of the medium: thermal conductivity, heat capacity, density and dynamic viscosity or thermal conductivity, thermal diffusivity, density and dynamic viscosity, wherein:
a first temperature sensor of said at least two temperature sensors is heatable; and
a second temperature sensor of said at least two temperature sensors serves to provide the temperature of the measured medium.

15. The thermal, flow measuring apparatus as claimed in claim 14, wherein:
the thermal, flow measuring apparatus has an evaluation unit, which serves, based on the power for operating said heatable temperature sensor and the temperature difference between said at least two temperature sensors with the aid of the ascertained properties of the medium to ascertain the flow velocity and/or the flow of the measured medium through the measuring tube.

16. The thermal, flow measuring apparatus as claimed in claim 15, wherein:
said evaluation unit includes a means, which serves for calculating a characteristic curve based on the ascertained properties of the medium;
the characteristic curve is especially a characteristic line, said characteristic line serves to provide a functional relationship between the power for operating said heatable temperature sensor and the flow of the measured medium through the measuring tube.

17. The thermal, flow measuring apparatus as a claimed in claim 16, wherein:
the thermal, flow measuring apparatus is so embodied that the ascertaining of properties of the medium and the calculating of a characteristic curve occurs within a period of time of less than 1 s, preferably less than 30 ms.

18. The thermal, flow measuring apparatus as claimed in claim 14, wherein:
said at least one measuring transducer ascertains values of the following properties of the medium: thermal conductivity, heat capacity, density and dynamic viscosity or thermal conductivity, thermal diffusivity, density and dynamic viscosity.

19. The thermal, flow measuring apparatus as claimed in claim 14, wherein:
said one or more measuring transducers for ascertaining the thermal conductivity and/or the heat capacity and/or the thermal diffusivity and/or the density and/or the dynamic viscosity of the measured medium are arranged in or on a bypass of the measuring tube.

20. The thermal, flow measuring apparatus as claimed in claim 14, wherein:
said one or more measuring transducers for ascertaining the thermal conductivity and/or the heat capacity and/or the thermal diffusivity and/or the density and/or the dynamic viscosity of the measured medium are integrated in the measuring tube.

21. The thermal, flow measuring apparatus as claimed in claim 20, wherein:
said one or more measuring transducers are arranged on a rod-shaped insert, which protrudes inwardly into the measuring tube, especially radially into the measuring tube.

22. A method for determining and/or monitoring flow of a measured medium through a measuring tube by means of a flow measuring apparatus, comprising: at least two temperature sensors; and at least one measuring transducer for ascertaining the following properties of the medium: thermal conductivity, heat capacity, density and dynamic viscosity or thermal conductivity, thermal diffusivity, density and dynamic viscosity, wherein: a first temperature sensor of said at least two temperature sensors is heatable; and a second temperature sensor of said at least two temperature sensors serves to provide the temperature of the measured medium, the method comprising a step as follows:
ascertaining respective values of the following properties of the medium: thermal conductivity, heat capacity, density and dynamic viscosity or thermal conductivity, thermal diffusivity, density and dynamic viscosity.

23. The method as claimed in claim 22, further comprising the step of:
calculating a characteristic curve based on values of parameters of the medium.

24. The method as claimed in claim 23, further comprising the step of:
ascertaining the flow of the measured medium based on the characteristic curve and the power for operating the heatable temperature sensor and the temperature difference between the at least two temperature sensors.

25. The method as claimed in claim 22, wherein:
the ascertained values of the parameters of the medium are ascertained in continuously or discontinuously recurring measurements and there occurs a fitting of flow related values based on the currently ascertained values of parameters of the medium.

26. The use of a thermal, flow measuring apparatus comprising:
at least two temperature sensors; and at least one measuring transducer for ascertaining the following properties of the medium: thermal conductivity, heat capacity, density and dynamic viscosity or thermal conductivity, thermal diffusivity, density and dynamic viscosity, wherein: a first temperature sensor of said at least two temperature sensors is heatable; and a second temperature sensor of said at least two temperature sensors serves to provide the temperature of the measured medium,
the use ascertaining the flow velocity of a measured medium having time variable composition and/or for detecting a change in the medium during measurement operation of the thermal, flow measuring apparatus.
